(19) United States
(12) Patent Application Publication
(10) Pub. No.: US 2017/0366518 A1
(43) Pub. Date: Dec. 21, 2017

(54) SYSTEM AND METHOD FOR ACCELERATING CRYPTOGRAPHY OPERATIONS ON A PORTABLE COMPUTING DEVICE

(71) Applicant: QUALCOMM INCORPORATED, SAN DIEGO, CA (US)

(72) Inventors: YASHAVANTHA RAO NARASOJI RAO, HYDERABAD (IN); NARESH MARADANA, HYDERABAD (IN)

(21) Appl. No.: 15/186,679

(22) Filed: Jun. 20, 2016

(51) Int. Cl. H04L 29/06; H04L 9/08; H04L 9/32; G06F 12/14

(52) U.S. Cl. CPC H04L 63/0442; H04L 63/061; H04L 63/0435; G06F 12/1408; H04L 9/0844; H04L 9/3247; G06F 2212/1052

(57) ABSTRACT

Systems, methods, and computer programs are disclosed for accelerating cryptography operations on a portable computing device. One such method comprises receiving a request for a processor on a portable computing device to execute a cryptography algorithm. Prior to executing the cryptography algorithm, a performance of the portable computing device is increased from a current performance setting to an increased performance setting. The processor executes the cryptography algorithm at the increased performance setting. After completion of the cryptography algorithm, the portable computing device is reverted to the current performance setting.

### DESCRIPTION OF THE RELATED ART

Portable computing devices (e.g., cellular telephones, smart phones, tablet computers, portable digital assistants (PDAs), portable game consoles, wearable devices, and other battery-powered devices) and other computing devices continue to offer an ever-expanding array of features and services, and provide users with unprecedented levels of access to information, resources, and communications. To keep pace with these service enhancements, such devices have become more powerful and more complex. Portable computing devices now commonly include a system on chip (SoC) comprising a plurality of memory clients embedded on a single substrate (e.g., one or more central processing units (CPUs), a graphics processing unit (GPU), digital signal processors, etc.). The memory clients may read data from and store data in a dynamic random access memory (DRAM) memory system electrically coupled to the SoC via a double data rate (DDR) bus.

Portable computing devices commonly incorporate various types of cryptographic systems for providing secure data communication. Asymmetric cryptography, such as public key cryptography, is widely used in mobile platforms. The most common public key algorithms, named after their respective authors, are RSA (Rivest, Shamir and Adleman) and DH (Diffie & Hellman). Public key cryptography or asymmetric cryptography uses two kinds of keys: a public key that may be disseminated widely; and a private key that is known only to the owner. In a public key encryption system, any person can encrypt a message using the public key of the receiver, but such a message can be decrypted only with the receiver's private key. The strength of a public key cryptography system relies on the degree of difficulty (i.e., computational impracticality) for a properly generated private key to be determined from its corresponding public key. Therefore, the security of public key cryptography relies on complex mathematical equations.

Because of the mathematical complexity, however, it is time consuming to generate the key pairs and to execute these equations on existing mobile platforms. For example, key sizes may range anywhere from 512 bits to 4096 bits, which means the cryptography mathematical operations can involve very large numbers (e.g., 64 bytes to 512 bytes). Furthermore, existing mobile computing devices may yield an undesirable variable performance when generating the key pairs due to changing operational use cases. As known in the art, portable computing devices may adjust power consumption in accordance with operational use cases by varying processor performance (e.g., CPU frequency, bus bandwidth, etc.). For use cases that require higher performance, the CPU frequency and/or bus bandwidth may be increased. To conserve power, the CPU frequency and/or bus bandwidth may be decreased during less workload intensive use cases. Therefore, depending on which use case the system is in when key pair generation is initiated, there can be significant variations in the amount of time required to generate the key pairs using the complex mathematical equations that are common in public key cryptography systems.

Accordingly, there is a need for improved systems and methods for performing cryptography operations on portable computing devices.

### SUMMARY OF THE DISCLOSURE

Systems, methods, and computer programs are disclosed for accelerating cryptography operations on a portable computing device. One such method comprises receiving a request for a processor on a portable computing device to execute a cryptography algorithm. Prior to executing the cryptography algorithm, a performance of the portable computing device is increased from a current performance setting to an increased performance setting. The processor executes the cryptography algorithm at the increased performance setting. After completion of the cryptography algorithm, the portable computing device is reverted to the current performance setting.

Another embodiment is system for accelerating cryptography operations on a portable computing device. The system comprises a system on chip (SoC) and a cryptography module. The SoC comprises a processing device and a resource power manager for adjusting one or more performance settings of the portable computing device. The cryptography module is stored in a memory and executed by the processing device. The cryptography module is configured to receive a request for the processing device to execute a cryptography algorithm. Prior to executing the cryptography algorithm, the performance of the portable computing device is increased from a current performance setting to an increased performance setting. The cryptography algorithm is executed at the increased performance setting. After completion of the cryptography algorithm, the portable computing device is reverted to the current performance setting.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an embodiment of a system for accelerating key pair generation in a portable computing device.

FIG. 2 is a block diagram illustrating an embodiment of the cryptography controller of FIG. 1.

FIG. 3 is a flowchart illustrating an embodiment of a method implemented in the system of FIG. 1 for accelerating key pair generation.

FIG. 4 illustrates exemplary pseudocode for implementing the method for accelerating key pair generation in the system of FIG. 1.

FIG. 5 is a block diagram of an embodiment of a portable computing device for incorporating the system of FIG. 1.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone”, “wireless communication device,” and “wireless handset” are used interchangeably. With the advent of third generation (“3G”) wireless technology and four generation (“4G”), greater bandwidth availability has enabled more portable computing devices with a greater variety of wireless capabilities. Therefore, a portable computing device may include a cellular telephone, a pager, a PDA, a smartphone, a navigation device, a wearable device (e.g., a smart watch), a handheld computer with a wireless connection or link, or any other battery-powered computing device.

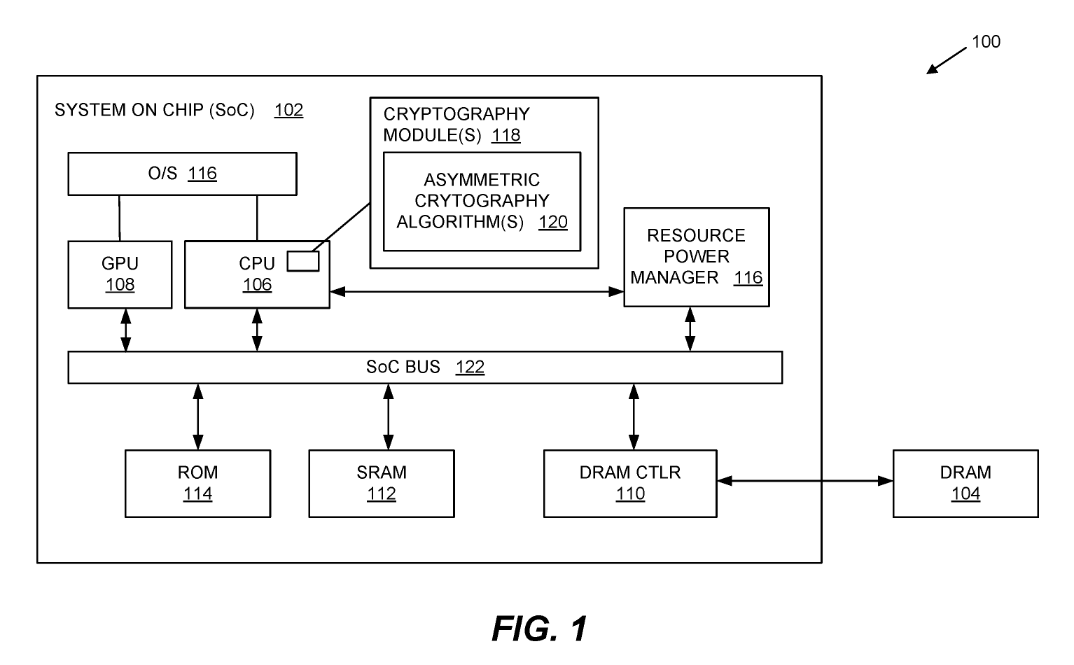

FIG. 1 illustrates an embodiment of a system 100 for accelerating key pair generation using an asymmetric cryptography algorithm. The system 100 may be implemented in any computing device, including a personal computer, a workstation, a server, or a portable computing device (PCD), such as a cellular telephone, a smart phone, a portable digital assistant (PDA), a portable game console, a navigation device, a tablet computer, a wearable device (e.g., smart watch), or other battery-powered portable device.

As illustrated in FIG. 1, the system 100 comprises a system on chip (SoC) 102 electrically coupled to a memory system via a memory bus. In the embodiment of FIG. 1, the memory system comprises a dynamic random access memory (DRAM) 104 coupled to the SoC 102 via a random access memory (RAM) bus (e.g., a double data rate (DDR) bus). The SoC 102 comprises various on-chip components, including a plurality of memory clients, a resource power manager 116, a DRAM controller 110 interconnected via a SoC bus 122. The memory clients may comprise one or more processing units (e.g., a central processing unit (CPU) 106, a graphics processing unit (GPU) 108, a digital signal processor (DSP), or other memory clients requesting read/write access to the memory system. The system 100 further comprises a high-level operating system (HLOS) 116. The SoC 102 may further comprise on-chip memory devices, such as, static random access memory (SRAM) 112 and read only memory (ROM) 114.

As illustrated in FIG. 1, the CPU 106 is configured to execute various software-based cryptography operations. In an embodiment, the CPU 106 executes cryptography module(s) 118, which may include one or more cryptography mathematical algorithms 120. It should be appreciated that the cryptography operations may involve, for example, encryption, decryption, key pair generation, digital signature algorithms (DSA). In an embodiment, the cryptography mathematical algorithms 120 support public key cryptography or asymmetric cryptography for generating public and private key pairs using, for example, a DH/RSA algorithm. In this regard, it should be appreciated that regardless the type of cryptography algorithms employed, cryptography modules 118 may involve execution of complex mathematical operations, such as the following equation:
(a**x mod p), where:
a is base;
x is exponent;
p is modulus;
** is exponentiation operation; and
mod is modulus operation

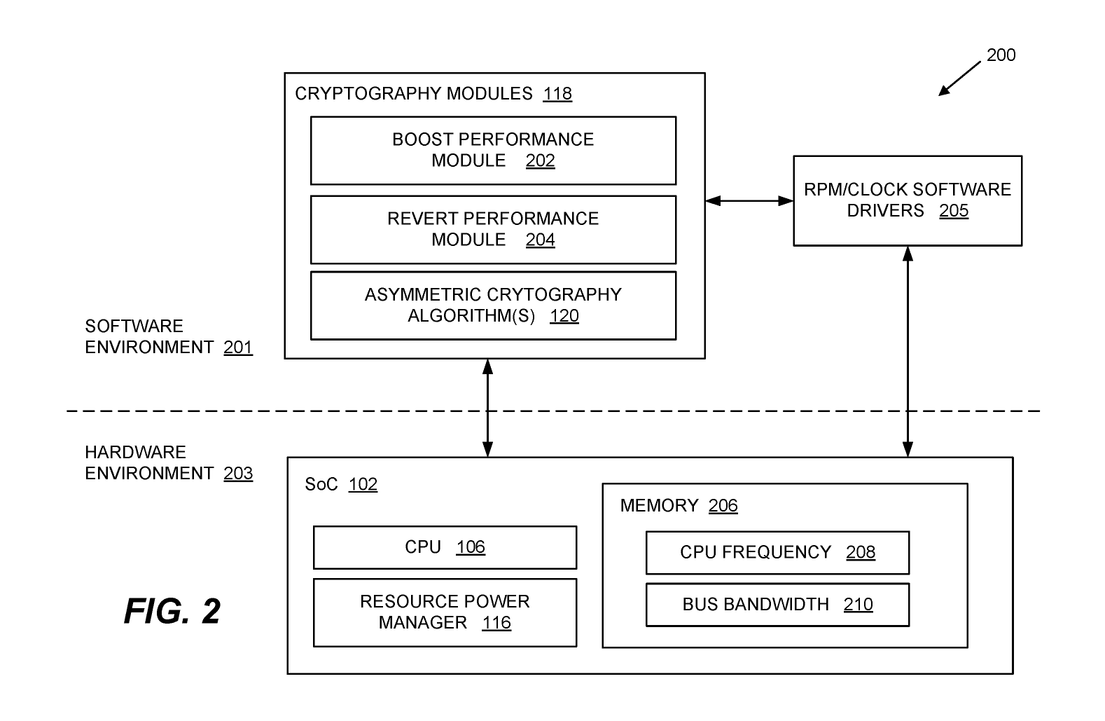

Referring to FIG. 2, the system 100 may comprise a software environment 201 and a hardware environment 203. The software environment 201 comprises the cryptography modules 118 executed by the CPU 106, as well as, software drivers associated with the CPU 106 and/or the RPM 116. (e.g., RPM/clock software drivers 205). The hardware environment 203 may comprise a resource power manager 116 electrically coupled to the CPU 106. The resource power manager 116 may be configured to adjust one or more performance settings of the system 100 in accordance with conventional operational use cases. In an embodiment, the resource power manager 116 may adjust the CPU frequency and/or bus bandwidth. It should be appreciated that the energy efficiency and power consumption of the system 100 may be managed to meet performance demands, workload types, etc. The system 100 may manage power consumption via dynamic clock and voltage scaling (DCVS) techniques. As known in the art, DCVS involves selectively adjusting the frequency and/or voltage applied to the processors, hardware devices, etc. to yield the desired performance and/or power efficiency characteristics. The resource power manager 116 may incorporate, or otherwise control, a DCVS controller or frequency controller used to adjust the operating frequency of the processor device(s) and/or the memory system to control memory bandwidth.

In a default mode of operation, the resource power manager 116 operates in a conventional manner to manage energy efficiency and power consumption of the system 100, according to various use cases, by adjusting one or more performance settings of the system 100 (e.g., CPU frequency, bus bandwidth, etc.). In another mode of operation (referred to as “accelerated cryptography”), the resource power manager 116 cooperates with the cryptography modules 118 to accelerate cryptography operations while operating in the various use cases.

As described below in more detail, accelerated cryptography operations generally involves temporarily interrupting the default mode of operation when the system 100 requests cryptography operations (e.g., key pair generation, encryption, decryption, DSA, etc.) via the cryptography algorithm(s) 120. In response the request to execute a cryptography algorithm, the cryptography modules 118 may interrupt the default mode of operation of the resource power manager 116 before executing one or more of the cryptography algorithm(s) 120. Prior to executing the cryptography operations, the cryptography module 118 may determine the current performance setting(s) associated with the system 100 (e.g., a current CPU frequency, a current bus bandwidth, etc.). A boost performance module 202 may be configured to boost or increase the performance setting(s) and then initiate execution of the cryptography algorithms 120 at the increased performance setting(s). After cryptography operations are executed, a revert performance module 204 may revert the system 100 to the prior performance setting(s) and return the system 100 to the default mode of operation until a subsequent request is received.

It should be appreciated that, depending on the current operational use case of the system 100 when the request is received for the CPU 106 to initiate cryptography operations, the system 100 may be operating at less than the performance setting(s) for optimally executing the software-based cryptography mathematical operations. For example, the CPU frequency and/or the bus bandwidth may be currently set to a lower operational range to accommodate a relatively lower workload use case and/or to conserve system power. If the cryptography algorithms 120 were to be performed at these current “lower” performance setting(s), the system 100 may take longer than desired to execute the computation-intensive demands of the cryptography algorithms 120. This would lead to problematic variable performance of cryptography operations due to the varying operational use cases.

In this regard, prior to initiating cryptography operations, the cryptography module 118 may determine the current performance setting(s). As illustrated in FIG. 2, the cryptography module 118 may receive the current performance setting(s) from the resource power manager 116 or other components in the system 100. If the current performance setting(s) are insufficient to timely perform the mathematical operations associated with the cryptograph algorithms 120 (e.g., generate a public key) or otherwise provide consistent cryptography performance), the cryptography module 118 may store the current performance setting(s) in a memory 206. The memory 206 may reside on the SoC 102 or may comprise other memory in the system 100 (e.g., ROM 114, SRAM 112, DRAM 104). In the embodiment of FIG. 2, a current CPU frequency setting 208 and a current bus bandwidth setting 210 may be stored in the memory 206.

It should be appreciated that the boost performance module 202 may be configured to instruct the resource power manager 116 (e.g., via the software drivers 205) to increase the performance setting(s) from the current performance setting(s) to one or more increased performance settings. The increased performance setting(s) may be computed by the boost performance module 202 to provide a consistent cryptography algorithm performance (e.g., consistent execution time for encryption, decryption, DSA, key pair generation, etc.) depending on, for example, the key bit size, the strength of the algorithm, etc. The increased performance setting(s) may be computed or otherwise determined based on predefined use cases. For example, in an embodiment, the performance setting(s) may be increased to a maximum setting (e.g., max CPU frequency, a higher bus bandwidth, etc.).

After cryptography operations are executed at the increased performance setting(s) and completed, the revert performance module 204 may access the memory 206 to determine the prior performance setting(s), instruct the resource power manager 116 to revert to the prior performance setting(s), and then return the system 100 to the default mode of operation until another cryptography request is received.

It should be appreciated that the boost and revert instructions initiated by the cryptography module 118 may be implemented in various ways. In an embodiment, the boost and revert instructions may comprise a corresponding vote (i.e., increase or decrease, respectively) via software drivers 205 to a CPU clock controller and/or a bus controller.

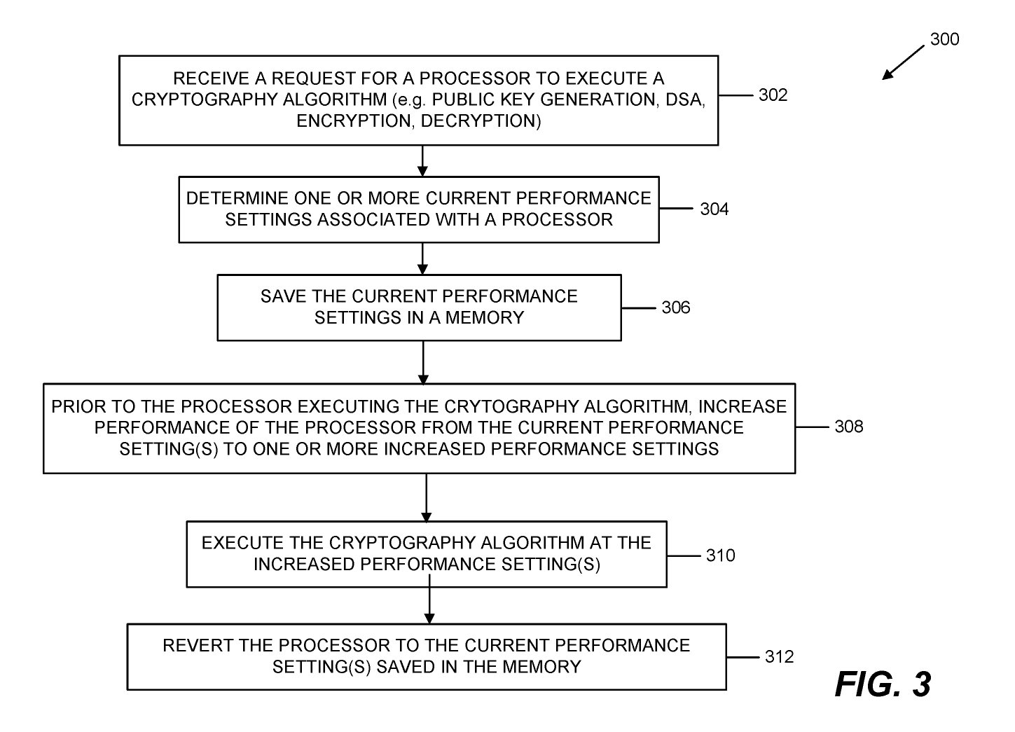

FIG. 3 illustrates an embodiment of a method 300 for implementing accelerated cryptography operations in the system 100. At block 302, the cryptography module 118 receives a request for the CPU 106 to execute one or more software-based cryptography algorithms 120. In response to the request, at block 304, the cryptography module 118 determines one or more performance settings associated with the current default mode of operation of the system 100. As described above, in the default mode of operation, the energy efficiency and power consumption of the system 100 is managed, according to various use cases, by adjusting one or more performance settings of the system 100 (e.g., CPU frequency, bus bandwidth, etc.). The cryptography module 118 may determine the current performance setting(s), as described above, via communication with the resource power manager 116 or associated components in the system 100. At block 306, the cryptography module 118 may store the current performance setting(s) in a memory for later access.

Prior to the CPU 106 executing the cryptography algorithms 120, at block 308, the performance of the system 100 is increased. As described above, the cryptography module 118 may instruct the resource power manager 116 to boost system performance by increasing one or more current performance setting(s) associated with the current default mode of operation to one or more increased performance setting(s). At block 310, the CPU 106 may execute the cryptography algorithms 120 at the increased performance setting(s). In this manner, the mathematical operations associated with the cryptography algorithms 120 may be executed without unnecessary delay or unpredictable performance resulting from changing use cases. After cryptography operations are completed, at block 312, the system 100 may be reverted to the prior performance setting(s) and returned to the default mode of operation. In an embodiment, the revert performance module 204 may access the memory 206 to determine the prior performance setting(s) and then instruct the resource power manager 116 to initiate the appropriate revert instructions.

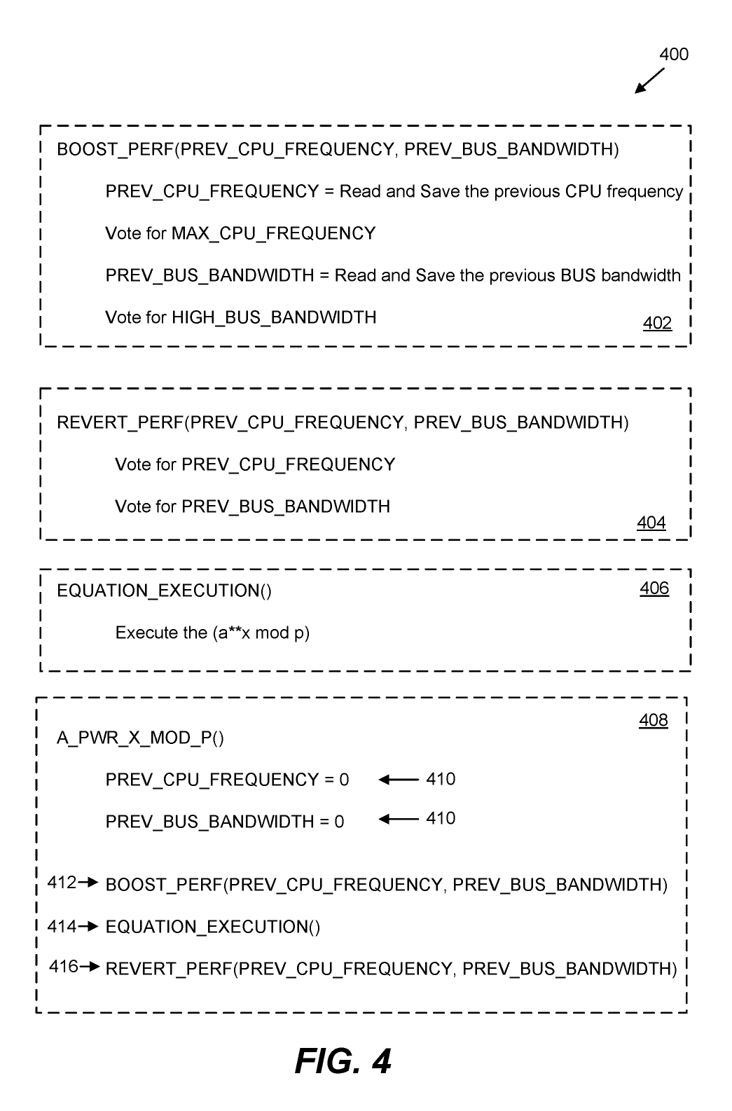

FIG. 4 illustrates exemplary pseudocode 400 for implementing accelerated key pair generation in the system 100. One of ordinary skill in the art will readily appreciate that these exemplary pseudocode instructions may implemented in any desirable computer language, logic, etc. (e.g., hardware, software, firmware) that may be stored in the system 100 and executed by a processing device, such as, CPU 106. As illustrated in FIG. 4, the pseudocode 400 comprises code 402, code 404, code 406, and code 408. Code 408 comprises the main logic for implementing accelerated key generation. Code 402 comprises the logic for boosting one or more performance setting(s) prior to executing key pair generation. Code 406 comprises the logic for executing the equations associated with the asymmetric cryptography algorithms 120. Code 408 comprise the logic for reverting to the prior performance setting(s) after key pair generation has completed. Referring to code 408, when accelerated key generation is initiated, the variables “PREY_CPU_FREQUENCY” and “PREY_BUS_BANDWIDTH” may be initialized (lines 410). After initializing these variables, a function call (line 412) is made to code 402 to boost performance. As illustrated in FIG. 4, the code 402 may read and save the previous CPU frequency and bus bandwidth, as well as, initiate a vote for a maximum CPU frequency and a higher bus bandwidth. After code 402 is executed, a functional call (line 414) is made to code 406 to execute key pair generation. After code 406 is executed, a functional call (line 416) is made to code 404 to revert to the previous CPU frequency and bus bandwidth by initiating associated votes.

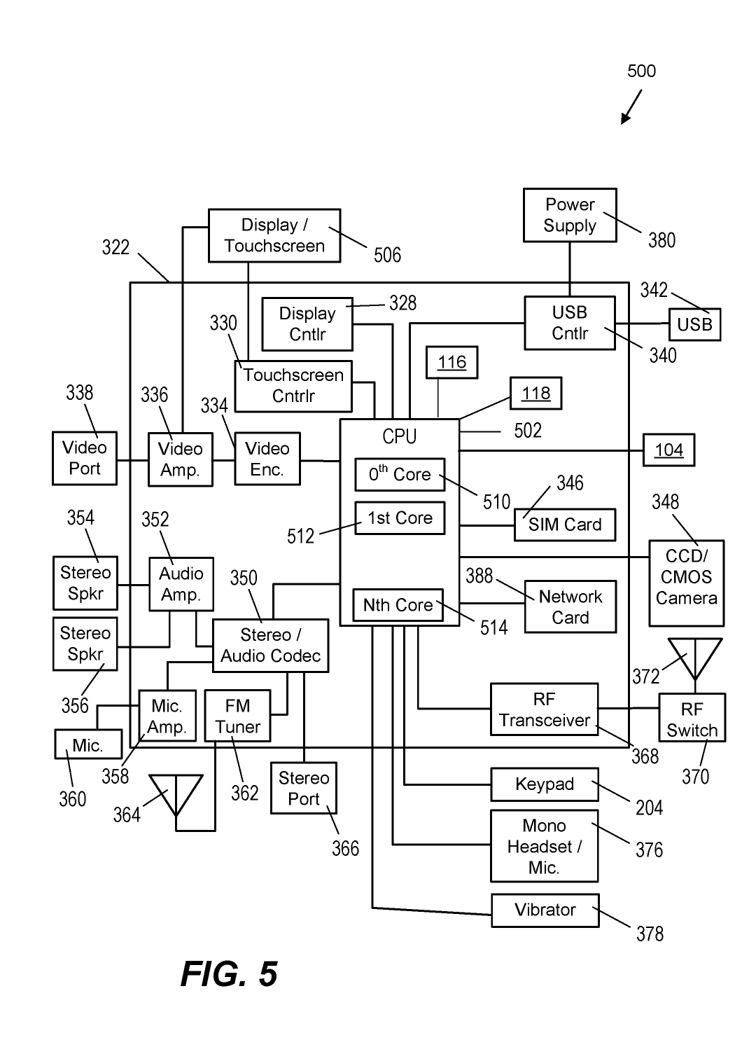

As mentioned above, the system 100 may be incorporated into any desirable computing system. FIG. 5 illustrates the system 100 incorporated in an exemplary portable computing device (PCD) 500. It will be readily appreciated that certain components of the system 100 (e.g., RPM 116 and cryptography controller 118) are included on the SoC 322 (FIG. 5) while other components (e.g., the DRAM 104) are external components coupled to the SoC 322. The SoC 322 may include a multicore CPU 502. The multicore CPU 502 may include a zeroth core 510, a first core 512, and an Nth core 514. One of the cores may comprise, for example, a graphics processing unit (GPU) with one or more of the others comprising the CPU.

A display controller 328 and a touch screen controller 330 may be coupled to the CPU 502. In turn, the touch screen display 506 external to the on-chip system 322 may be coupled to the display controller 328 and the touch screen controller 330.

FIG. 5 further shows that a video encoder 334, e.g., a phase alternating line (PAL) encoder, a sequential color a memoire (SECAM) encoder, or a national television system(s) committee (NTSC) encoder, is coupled to the multicore CPU 502. Further, a video amplifier 336 is coupled to the video encoder 334 and the touch screen display 506. Also, a video port 338 is coupled to the video amplifier 336. As shown in FIG. 5, a universal serial bus (USB) controller 340 is coupled to the multicore CPU 502. Also, a USB port 342 is coupled to the USB controller 340. Memory 104 and a subscriber identity module (SIM) card 346 may also be coupled to the multicore CPU 502.

Further, as shown in FIG. 5, a digital camera 348 may be coupled to the multicore CPU 502. In an exemplary aspect, the digital camera 348 is a charge-coupled device (CCD) camera or a complementary metal-oxide semiconductor (CMOS) camera.

As further illustrated in FIG. 5, a stereo audio coder-decoder (CODEC) 350 may be coupled to the multicore CPU 502. Moreover, an audio amplifier 352 may be coupled to the stereo audio CODEC 350. In an exemplary aspect, a first stereo speaker 354 and a second stereo speaker 356 are coupled to the audio amplifier 352. FIG. 5 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 5 further illustrates that a radio frequency (RF) transceiver 368 may be coupled to the multicore CPU 502. An RF switch 370 may be coupled to the RF transceiver 368 and an RF antenna 372. A keypad 204 may be coupled to the multicore CPU 502. Also, a mono headset with a microphone 376 may be coupled to the multicore CPU 502. Further, a vibrator device 378 may be coupled to the multicore CPU 502.

FIG. 5 also shows that a power supply 380 may be coupled to the on-chip system 322. In a particular aspect, the power supply 380 is a direct current (DC) power supply that provides power to the various components of the PCD 500 that require power. Further, in a particular aspect, the power supply is a rechargeable DC battery or a DC power supply that is derived from an alternating current (AC) to DC transformer that is connected to an AC power source.

FIG. 5 further indicates that the PCD 500 may also include a network card 388 that may be used to access a data network, e.g., a local area network, a personal area network, or any other network. The network card 388 may be a Bluetooth network card, a WiFi network card, a personal area network (PAN) card, a personal area network ultra-low-power technology (PeANUT) network card, a television/cable/satellite tuner, or any other network card well known in the art. Further, the network card 388 may be incorporated into a chip, i.e., the network card 388 may be a full solution in a chip, and may not be a separate network card 388.

As depicted in FIG. 5, the touch screen display 506, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 may be external to the on-chip system 322.

It should be appreciated that one or more of the method steps described herein may be stored in the memory as computer program instructions, such as the modules described above. These instructions may be executed by any suitable processor in combination or in concert with the corresponding module to perform the methods described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for accelerating cryptography operations on a portable computing device, the method comprising:
receiving a request for a processor on a portable computing device to execute a cryptography algorithm;
prior to executing the cryptography algorithm, increasing performance of the portable computing device from a current performance setting to an increased performance setting;
executing the cryptography algorithm at the increased performance setting; and
after completion of the cryptography algorithm, reverting the portable computing device to the current performance setting.

2. The method of claim 1, wherein the cryptography algorithm comprises a public key cryptography algorithm.

3. The method of claim 1, wherein the cryptography algorithm comprises one of a Rivest Shamir Adleman (RSA) algorithm and a Diffie Hellman (DH) algorithm.

4. The method of claim 1, wherein the cryptography algorithm involves one of a digital signature authentication process, a public key pair generation process, an encryption process, and a decryption process.

5. The method of claim 1, wherein the increasing the performance of the portable computing device from the current performance setting to the increased performance setting comprises: sending a vote for an increased CPU frequency or an increased bus bandwidth.

6. The method of claim 1, further comprising:
prior to executing the cryptography algorithm, storing the current performance setting in a memory;
wherein the reverting the portable computing device to the current performance setting comprises accessing the memory.

7. The method of claim 1, wherein the portable computing device comprises one of a mobile phone, a tablet computer, and a wearable device.

8. A system for accelerating cryptography operations on a portable computing device, the system comprising:
means for receiving a request for a processor on a portable computing device to execute a cryptography algorithm;
means for increasing performance of the portable computing device from a current performance setting to an increased performance setting prior to executing the cryptography algorithm;
means for executing the cryptography algorithm at the increased performance setting; and
means for reverting the portable computing device to the current performance setting after completion of the cryptography algorithm.

9. The system of claim 8, wherein the cryptography algorithm comprises a public key cryptography algorithm.

10. The system of claim 8, wherein the cryptography algorithm comprises one of a Rivest Shamir Adleman (RSA) algorithm and a Diffie Hellman (DH) algorithm.

11. The system of claim 8, wherein the cryptography algorithm involves one of a digital signature authentication process, a public key pair generation process, an encryption process, and a decryption process.

12. The system of claim 8, wherein the means for increasing the performance of the portable computing device from the current performance setting to the increased performance setting comprises: means for sending a vote for an increased CPU frequency or an increased bus bandwidth.

13. The system of claim 8, further comprising:
means for storing the current performance setting in a memory prior to executing the cryptography algorithm;
wherein the means for reverting the portable computing device to the current performance setting comprises: means for accessing the memory.

14. The system of claim 8, wherein the portable computing device comprises one of a mobile phone, a tablet computer, and a wearable device.

15. A computer program embodied in a memory and executable by a processor for implementing a method for accelerating cryptography operations on a portable computing device, the method comprising:
receiving a request for a processor on a portable computing device to execute a cryptography algorithm;
prior to executing the cryptography algorithm, increasing performance of the portable computing device from a current performance setting to an increased performance setting;
executing the cryptography algorithm at the increased performance setting; and
after completion of the cryptography algorithm, reverting the portable computing device to the current performance setting.

16. The computer program of claim 15, wherein the cryptography algorithm comprises a public key cryptography algorithm.

17. The computer program of claim 15, wherein the cryptography algorithm comprises one of a Rivest Shamir Adleman (RSA) algorithm and a Diffie Hellman (DH) algorithm.

18. The computer program of claim 15, wherein the cryptography algorithm involves one of a digital signature authentication process, a public key pair generation process, an encryption process, and a decryption process.

19. The computer program of claim 15, wherein the increasing the performance of the portable computing device from the current performance setting to the increased performance setting comprises: sending a vote for an increased CPU frequency or an increased bus bandwidth.

20. The computer program of claim 15, wherein the method further comprises:
prior to executing the cryptography algorithm, storing the current performance setting in a memory;
wherein the reverting the portable computing device to the current performance setting comprises accessing the memory.

21. The computer program of claim 15, wherein the portable computing device comprises one of a mobile phone, a tablet computer, and a wearable device.

22. A system for accelerating cryptography operations on a portable computing device, the system comprising:
a system on chip (SoC) comprising a processing device and a resource power manager for adjusting one or more performance settings of a portable computing device; and
a cryptography module stored in a memory and executed by the processing device, the cryptography module configured to:
receive a request for the processing device to execute a cryptography algorithm;
prior to executing the cryptography algorithm, increase performance of the portable computing device from a current performance setting to an increased performance setting;
execute the cryptography algorithm at the increased performance setting; and
after completion of the cryptography algorithm, revert the portable computing device to the current performance setting.

23. The system of claim 22, wherein the cryptography algorithm comprises a public key cryptography algorithm.

24. The system of claim 22, wherein the cryptography algorithm comprises one of a Rivest Shamir Adleman (RSA) algorithm and a Diffie Hellman (DH) algorithm.

25. The system of claim 22, wherein the cryptography algorithm involves one of a digital signature authentication process, a public key pair generation process, an encryption process, and a decryption process.

26. The system of claim 22, wherein the increasing the performance of the portable computing device from the current performance setting to the increased performance setting comprises: sending a vote for an increased CPU frequency or an increased bus bandwidth.

27. The system of claim 22, wherein the cryptography module is further configured to:
prior to executing the cryptography algorithm, store the current performance setting in a memory;
wherein the reverting the portable computing device to the current performance setting comprises accessing the memory.

28. The system of claim 22, wherein the processor device comprises a central processing unit (CPU).

29. The system of claim 22, wherein the portable computing device comprises one of a mobile phone, a tablet computer, and a wearable device.

30. The system of claim 22, wherein the increased performance setting of the portable computing device comprises one of a processing device frequency and a memory bus bandwidth.
